(19) United States
(12) Patent Application Publication
(10) Pub. No.: US 2008/0254696 A1
(43) Pub. Date: Oct. 16, 2008

(54) Plastisol Composition, a Breathable and Absorbent Polymeric Material, Process and Use Therefor

(75) Inventor: Aniceto Alves Braga, Sao Jose dos Campos-SP (BR)

Correspondence Address: SUGHRUE MION, PLLC, 2100 PENNSYLVANIA AVENUE, N.W., SUITE 800, WASHINGTON, DC, 20037, US

(73) Assignees: DELTACAP 430 PARTICIPACOES LTDA, Rio de Janeiro - RJ (BR); CIPATEX IMPREGNADORA DE PAPEIS E TECIDOS LTDA., Cerquilho - SP (BR)

(21) Appl. No.: 12/067,118

(22) PCT Filed: Sep. 13, 2006
(86) PCT No.: PCT/BR2006/000186

§ 371 Date: Mar. 17, 2008

(30) Foreign Application Priority Data
Sep. 16, 2005 (BR) PI 0506091-5
Aug. 30, 2006 (BR) PI 0603847-6

(51) Int. Cl. B32B 5/18; B05D 3/02; C08L 27/06

(52) U.S. Cl. 442/76; 427/385.5; 156/324; 525/214

(57) ABSTRACT

The present invention refers to a plastisol composition of an organic polymer, comprising water and at least one non-crosslinked, water-soluble polyelectrolyte. The invention also covers materials obtained from said composition, the process to obtain them and uses for said materials.

### FIELD OF THE INVENTION

The invention refers, in a first aspect, to a plastisol composition comprising water and at least one polyelectrolyte and its use to obtain breathable materials. In a particular embodiment, it refers to a polyvinyl chloride plastisol comprising water and one or more polyelectrolytes selected from polyacrylamide, polyacrylic acid or sodium polyacrylate.

The invention also refers to a breathable and absorbent polymeric material obtained from said composition. Said material, typically film-like, comprises small channels or irregular ducts generically orthogonal to its main plane, allowing the circulation of gases, e.g. air, or humidity, thus justifying its breathability and absorption. Such a material may be a monolayer or multilayer film, optionally comprising at least one textile substrate. In a particular embodiment of the invention, it is a polyvinyl chloride-based film. In another particular embodiment such material imitates animal leather, being a polyvinyl chloride composite with textile material, providing stable physical and mechanical features, good breathability and absorption.

In yet another aspect, the invention refers to a process to obtain a monolayer or multilayer laminar material, optionally in the form of a composite with flexible, breathable and absorbent textile material, with said composition as raw material.

The invention also refers to the use of said polymeric material to obtain manufactured articles, particularly based on polyvinyl chloride plastisol with textile material, e.g. for automobile, furniture, clothing or footware covering.

### BACKGROUND OF THE INVENTION

As a definition used herein, polyelectrolytes are polymers whose monomeric units contain at least one electrolyte group which dissociates in aqueous solutions, providing polymers with electrical charge or polarity. Therefore, the properties of polyelectrolytes, sometimes called poly-salts, are similar to both electrolytes (salts) and polymers (high molecular weight compounds). Just like salts, their solutions are electrically conductive. Just like polymers, their solutions are frequently viscous.

As a definition used herein, plastisols are organic polymer dispersions in plasticizers, forming gel on heating to relatively high temperatures and solidifying when cured. In practice, the vast majority of plastisols used is based on finely divided polyvinyl chloride which is dispersed in a plasticizing liquid, forming a paste. However, there are many other plastisols, such as the ones disclosed in the German patent documents DE 2,454,235 and DE 2,529,732, based on acrylate. The European patent document EP 0,261,499 discloses plastisols based on styrene/acrylonitrile copolymers. The German patent document DE 4,139,382 discloses plastisols based on core/shell polymers, wherein the core of an elastomer is a diene and the shell is a continuous layer of methyl metacrylate or polyvinyl chloride resin. The term “plastisol” should therefore not be understood, by any means, as limitative to just polyvinyl chloride, even if it is mentioned in particular embodiments of the invention.

One finds definitions as to what a plasticizer is and data on the physical-chemical interaction between plasticizers and synthetic resins in the publication by K. Weinmann, Beschichten mit Lacken und Kunststoffen, Verlag W. A. Colomb, Stuttgart, Germany, 1967, pages 47 to 158. The compatibility between a large number of plasticizers and various polymers is discussed by the authors F. Stuhlen and L. Meier in the publication Kunststoff-Rundschau, 19, pages 251 to 260 and 316 to 319 (1972).

In the following text, there is frequent mention to synthetic leather, just as a particular example of a material of the invention, not creating any limitation to just this embodiment.

The prior art teaches about flexible composites with textile materials, e.g. covered or linked to polymeric materials such as polyurethane (PU) and polyvinyl chloride (PVC). They are typically substitutes or imitations of animal leather, also called synthetic leather or ecological leather.

There is a large volume of technical information on how to obtain synthetic leather. Commercially, PU composites are the ones nearest to the quality of animal leather, particularly for the manufacture of general upholstery, clothing and footwear, and especially because of the fact that PU composites present breathability and absorption characteristics.

It is known that PU composites used as artificial leather bear the disadvantage of using high cost raw material. The PU composite provided with breathability and absorption characteristics is particularly more costly due to its specific industrial process, i.e. coagulation. Such a breathable and absorbent PU composite also bears limitations for being unable to keep such characteristics with thicknesses above 0.8 millimeters.

Therefore, there are great efforts to improve this kind of product or to substitute it for other materials. Additionally, although the known laminated PVC composite is cheaper, there is no news of success in its use in commercial products with features which are nearer to animal leather, especially regarding breathability and absorption.

### DESCRIPTION OF THE INVENTION

The present invention, in one aspect, adds in a simple and practical way the attributes of breathability and absorption to synthetic leathers, especially PVC-based ones, keeping other characteristics found in conventional synthetic leather products, among which: (i) resilience; (ii) resistance to glueing; (iii) resistance to weaving; (iv) resistance to flexure; (v) resistance to abrasion; (vi) color fastness and others; besides its capacity to simulate animal leather both in feel and appearance.

The invention deals, in a first aspect, with a plastisol composition characterized by the fact that it contains water and one or more polyelectrolytes. The use of polyelectrolytes bears the important purpose of retaining water (chemically, under the form of the so-called co-ordinated water) so that, by means of its controlled release as water vapor (which ordinarily happens by exposition to heat) during the curing process of said matrix, it forms interconnected channels or ducts within the polymeric matrix; which may also promote its expansion.

The use of said composition in traditional processes for textile material composites, typically synthetic laminates, with adaptations that the one skilled in the art knows how to do, leads to obtaining a highly breathable and absorbent material, also keeping in a stable form the same physical and mechanic characteristics of conventional PVC synthetic flexible laminates. Concerning breathable PU synthetic laminates, the material as obtained with the technology of the invention holds significant advantages on cost, production process and thickness limitation.

Without imposing limitations to the invention by the following theoretical explanation, the absorption promoted by the material of the invention occurs thanks both to the holding of liquid within the channels formed during the process to obtain it, and (if configured as a polymer composite obtained from a plastisol with a textile substrate), by the ability to allow the passage of liquid towards absorbing material present near its surface.

Within a particularly preferred aspect, the invention refers to a PVC plastisol composition characterized by comprising water and at least one polyelectrolyte, preferably chosen from polyacrylamide, polyacrylic acid and sodium polyacrylate.

Not imposing any limitation to the invention as a function of theoretical interpretations, a surprising aspect is the presence of water in a plastisol, in opposition to the usual knowledge of persons skilled in the art, who would allege incompatibility with other components and interference in the stability of the productive process. Polyelectrolytes chemically retain water by means of electrostatic forces (hydrogen bridges or Van de Waals forces). It is verified that, while the plastisol is heated to promote its cure, thus up to above 100° C., said chemically linked water starts to vaporize and be expelled from the mass (in comparison with free water, which simply evaporates), thus in its way out creating passages in the form of channels along the thickness of the gel. Said channels remain after curing, cooling and consequent hardening of the obtained material. Said water, which is chemically retained by polyelectrolyte polarity above the ordinary water boiling point, is responsible for vapor emission, which itself causes the formation of channels, i.e. it is the agent providing a material with breathing and absorption capacities.

An aspect of the invention is therefore the expelling of water from the polymeric mass along a wide range of temperatures, thus obtaining as a final result a breathable and absorbent product.

Advantageously, channels or ducts obtained through the mass of material, whose formation may be controlled to reach desired breathability and absorption values, have random shapes caused by water expansion in its vapor form and its expelling from the product. Said random aspect in materials such as synthetic leather more perfectly simulates a natural material in comparison to known mechanic and symmetric perforation processes.

The breathable material of the invention, such as a PVC-based composite material with textile substrate, presents a series of characteristics making it interesting for several applications, particularly as synthetic leather:
breathability: high vapor and gas passage capacity. Pore formation may be controlled by the kind and quantity of polyelectrolyte, and the quantity of water;
absorption: selective liquid absorption capacity, i.e. the liquid contacting the external (plastic) surface of the substrate, for a limited period of time, cannot go through the porous structure and contact the substrate on the base of the composite. However, if the liquid remains in contact with the external surface for enough time, it is able to go through its porous structure, reaching the tissue on the base of the composite, showing absorption effect. Pore formation control also allows controlling said absorption characteristic;
Color fastness: to obtain a color stability pattern is a strongly desired characteristic in synthetic laminates, and the plastisol composition of the invention allows obtaining color fastness under acceptable standards by the industry;
Feel: touch characteristics similar to leather;
Flexure: properties obtained by conventional PVC composites are maintained;
Mechanical resistance to tear and abrasion: properties obtained by conventional PVC composites are maintained;
Cost: lower and simpler industrial process over similar polyurethane-based composites. It does not require specific machinery, nor does it promote significant changes in cost in comparison to PVC conventional plastisol;
Higher flexibility in thickness definition over similar polyurethane-based composites, specifically in the development of thicker materials.

In the preparation of the plastisol of the invention, the following quantities are appropriate, which do not represent any limitation other than those present in the attached claims:
0.01% to 10%, particularly 0.02% to 5% by weight of polyelectrolyte with respect to the total weight of the composition;
0.1% to 35% of water, particularly 0.5% to 10% by weight of water, with respect to the total weight of the composition.

Some polyelectrolytes, e. g. polyacrylamide, may be commercially found in water solution and are appropriate for the invention. In the same fashion, alkali may be used in a water solution.

The presence of water in the plastisol formulation of the invention aims to form vapor during the process to obtain a plastisol-based material, said vapor being expelled from the polymeric mass, creating channels alongside it. The use of polyelectrolyte aims to retain water, controlling the moment when it is expelled, in the form of vapor, and consequently forming channels. The water may be used as such, as a diluent or solvent for one or more components of the composition, in a mixture with other liquids such as alcohol (in which case the formation of azeotrope under lower temperature than the boiling point of water is possible), or any other form. It is also understood that the formation of vapor which is expelled from the polymeric mass by heating, generating channels or ducts in its way out, may be obtained with other materials equivalent to water.

The mention to polyelectrolytes does not exclude any material, be it crosslinked or not, fully or partially polar, soluble or insoluble. The fact that a material is not known as a polyelectrolyte, but is able to provide water molecule coordination (i.e. chemical linkage of the Van der Waals type or similar) is understood herein as a polyelectrolyte.

As it is well known about polyelectrolyte behavior, the presence of alkali changes the quantity of polar terminals responsible for water coordination. Partially neutralized polyacrylic acid, for example, so as to obtain 30% acid and 70% sodium polyacrylate, is a very efficient polyelectrolyte, with high polar capacity, thus effective in water coordination, i.e. its chemical retention. Not excluding any other alkali known by the person skilled in the art, sodium hydroxide and ammonium hydroxide are appropriate to the invention. Said neutralization (or salinization) may be happen prior to mixing the polyelectrolyte in the formulation of plastisol, or formed in situ. Particularly, the quantity of alkali varies from 0.5% to 15%, more particularly between 5% and 10% of the total weight of the composition.

Polyelectrolytes of the invention may be homopolymers, copolymers, terpolymers or polymers constituted by any number of different monomeric blocks.

Quantities and proportions of conventionally components used in known plastisol compositions may be maintained in the composition of the invention. In the specific case of PVC plastisols, as the person skilled in the art knows, an appropriate quantity of PVC is about 30% to 50% by weight. It is also known that an appropriate quantity of plasticizer is about 40% to about 70% by weight. In a particular way to obtaining a plastisol, PVC from emulsion and suspension polymerization processes may be simultaneously used, for instance in a ratio of about 3:1. The person skilled in the art is familiar with the quantities, proportions and expected effects of common components used in preparing conventional flexible PVC composites, which are not a part of the invention per se.

Among conventional components used in PVC plastisols, one can mention as examples: plasticizers (such as dioctyl phthalate), thermal stabilizers, kickers, solvents (such as diethylene glycol, paraffinic hydrocarbons), fillers (e.g. calcium carbonate), antimicrobials, pigments and coloring agents, lubricants, antioxidizers, protectors against UV rays, etc. Also possibly, known additional expanding agents, such as azodicarbonamide and sodium carbonate may be used.

An appropriate plastisol is based on PVC, particularly homopolymer. However, PVC copolymers with other monomers are also within the scope of the invention.

The plastisol of the invention is stable, remaining available for use for long periods, especially at room temperature.

In another aspect, the invention also encompasses a process to obtain a polymeric material, such as a PVC film, provided with high breathability and absorption, by using the above composition. Said process consists of laying a layer of plastisol and heat it by any appropriate means, with sufficient time and temperature to gel the mass, to form and expel water vapor and to cure the gel, generating an expanded, breathable and absorbent substrate.

A process of the invention which is particularly appropriate to obtain a breathable and absorbent PVC composite material (not excluding any other polymer) is characterized by comprising the steps below, taken into account adaptations inherent to the invention relative to a conventional process:

a) spreading a layer of plastisol composition containing water and one or more electrolytes over the surface of a moving conductor support;

b) heating for appropriate time and temperature to start plastisol gelling and water evaporation;

c) optionally, further repeating steps a and b;

d) laying over a last layer of non-gelled plastisol a web of textile substrate;

e) heating until plastisol is gelled, water evaporates and the material exposed to heating is cured.

Advantageously, for each new layer spread over a previous layer, one uses a temperature higher than the previous used one, or longer exposition time to the same temperature, or still a combination of higher temperature and longer time.

The heating in any of the steps should be held for such time and temperature that avoids melting the solidified polymeric matrix, causing partial or full obstruction of the existing pores.

Alternatively, the layer of step a) of the process of the invention may be polyurethane. Also, the finishing of the composite can be made by any known means, such as by using other polymers, so as not to substantially harm the obtained porosity.

Particularly, one or more aspects below may be observed along the process of the invention:
the process is performed along a continuous processing line, particularly over a rolling mate, with speeds between 9 and 25 meters per minute, preferably between 12 and 13 meters per minute being appropriate;
plastisol is spread by spread coating in an appropriate equipment;
heating is applied by ovens along a 1 to 25 meter long processing line, preferably 8 to 15 meter long;
a particularly advantageous number of plastisol layers varies between 2 and 5, by using corresponding heating steps to gel and cure each layer, expelling water vapor;
the thickness of the PVC layers, not considering the textile substrate, may vary between 0.03 mm and 3 mm, preferably between 0.3 mm and 1.6 mm;
the conductive support over which plastisol is spread coated is preferably an appropriate paper, with or without high relief, such as a silicon paper (usually known as release paper), or other commercially available coverings indicated for the spread coating process;
appropriate temperatures to heat the plastisol along the process are between 130° C. and 230° C., preferably between 180° C. and 200° C., for e.g. two seconds to two minutes. An increasing heating profile is appropriate, favoring a slow release of vapor, so as to obtain a more uniform breathability capacity for the flexible composite material. As already mentioned, the exposure of the polymeric matrix to high temperature for long periods of time may soften the polymer, with the consequent obstruction of obtained pores;
the textile substrate used is any woven or nonwoven material, with preference to those that do not shrink under heat. Appropriate examples are microfiber and nonwoven textiles. Textile substrates, within a general understanding of the invention, are also understood as natural or artificial sponges, plastic or metal screens, flexible films of any nature and any other materials provided with flexibility which may be used for the composite material of the invention, with laminar or foil nature.

As another aspect of the invention, there is the use of the obtained material, such as a flexible composite material based on PVC plastisol containing water and one or more electrolytes, to manufacture automobile, furniture, clothing or footwear coverings.

Teachings as disclosed herewith allow the person skilled in the art to put into practice the invention as shown and also in equivalent ways, not for this reason being out of its scope of protection, which is only limited by the attached claims.

### EXAMPLES

The examples as mentioned below are given just as particular embodiments of the invention and should not be understood, under any circumstance, as imposing limitations to the invention differently from the attached claims.

### Determination of Permeability to Water Vapor

Samples of PVC plastisol composites were prepared and their permeability to water vapor was evaluated.

A plastisol composition was the same used in all samples, corresponding to a conventional composition, as currently used by PVC laminate manufacturers, as follows (Table I)

TABLE I
PLASTISOL COMPOSITION

| Component | Parts, by weigh |
|---|---|
| Calcium carbonate | 75 |
| Dioctyl phtalate | 90 |
| Stabilizer (1) | 2.2 |
| Homopolymer PVC powder from | 50 |
| emulsion polymerization process (2) | |
| Homopolymer PVC powder from | 75 |
| microsuspension polymerization | |
| process (3) | |
| Azodicarbonamide (4) in dioctyl | 6 |
| phtalate (100:80) | |

(1) K-219 - organic soap with zinc and potassium salts - from Inbra Indústrias Químicas Ltda, Brazil.
(2) Solvin 374 MBN - from Solvay Indupa do Brasil S/A
(3) Solvin 367 NK - from Solvay Indupa do Brasil S/A
(4) CS-4M - from Inbra Indústrial Químicas Ltda, Brazil.

The components of the compositions and their contents are disclosed on Table II below, expressed as a percentage by weight relative to the total weight of the composition.

All samples were prepared the same way, under the form of a PVC laminate composite with a nonwoven veil (Sontara®, 40 g, from Dupont do Brasil S/A, Brazil), by initially preparing a plastisol formulation, laying a quantity of the plastisol over a plain surface, laying over said layer the nonwoven veil and exposing said sample to a heating profile until it is gelled and cured. It can be seen that only sample 1, known in the prior art, no water vapor was formed and expelled. The test to determine permeability to water vapor was performed with cooled samples, according to the standard DIN EM ISO 20344:2004 item 6.6. Samples were previously acclimatized as per the Brazilian standard NBR 10455:1988 (tolerance range B, equivalent to standard DIN 50014:1985, class 2) for a minimum period of 24 hours at 23° C. and 50% relative humidity. Breathability results are also mentioned on the table below, in milligrams per square centimeter per hour.

TABLE II
COMPOSITIONS AND BREATHABILITY RESULTS

| | | | Polyelectrolyte | | | | |
|---|---|---|---|---|---|---|---|
| | | | | Poly | | | |
| Sample | Convent. | | Poly | acrylic | | | Breathability |
| n^{o} | plastisol | Ammonium | acrylamide | acid | Caustic | Water | (mg/cm2/h) |
| 1 | 100.00 | | | | | | 0.2 |
| 2 | 98.00 | | 0.02 | | | 1.98 | 0.5 |
| 3 | 97.50 | 0.50 | 0.02 | | | 1.98 | 0.6 |
| 4 | 89.80 | 5.00 | 0.20 | | | 5.00 | 4.1 |
| 5 | 83.60 | 8.00 | 0.40 | | | 8.00 | 6.6 |
| 6 | 98.00 | | | 0.02 | | 1.98 | 0.3 |
| 7 | 97.50 | 0.50 | | 0.02 | | 1.98 | 0.4 |
| 8 | 89.80 | 5.00 | | 0.20 | | 5.00 | 1.6 |
| 9 | 83.60 | 8.00 | | 0.40 | | 8.00 | 4.1 |
| 10 | 79.40 | 10.00 | | 0.60 | | 10.00 | 7.0 |
| 11 | 97.49 | | | 0.03 | 0.50 | 1.98 | 0.5 |
| 12 | 89.76 | | | 0.25 | 5.00 | 5.00 | 1.3 |
| 13 | 83.52 | | | 0.50 | 7.99 | 7.99 | 1.8 |
| 14 | 79.28 | | | 0.75 | 9.99 | 9.99 | 3.5 |

Results as obtained in the tests prove that the breathability of the materials of the invention are systematically higher than in sample 1, which was prepared with plastisol from the prior art. The presence of polyelectrolyte (optionally neutralized with alkali) and water under quantities as indicated, shows that breathability increased according to the type and content of electrolyte and water content. Particularly, the sample 10 was 350 times more breathable than sample 1 of the prior art.

It must be remarked that the teachings and examples as presented herein allow the persons skilled in the art to promote changes in various aspects of the invention which, although not expressly mentioned, are equivalent means, as they do not avoid the guidelines established in this document as to functions and results, therefore being encompassed by the invention.

1. PLASTISOL COMPOSITION, characterized by the fact that it comprises water and at least one non-crosslinked, water-soluble polyelectrolyte.

2. COMPOSITION of claim 1, characterized by the fact that the content of polyelectrolyte is from 0.01% to 10% by weight relative to the total weight of the composition.

3. COMPOSITION of claim 1, characterized by the fact that the content of polyelectrolyte is from 0.02% to 5% by weight relative to the total weight of the composition.

4. COMPOSITION of claim 1, characterized by the fact that the content of water is from 0.1% to 35% by weight relative to the total weight of the composition.

5. COMPOSITION of claim 1, characterized by the fact that the content of water is 0.5% to 10% by weight relative to the total weight of the composition.

6. COMPOSITION of claim 1, characterized by the fact that the polyelectrolyte is chosen from polyacrylamide, polyacrylic acid and sodium acrylate.

7. COMPOSITION of claim 1, characterized by the fact that said plastisol is a PVC plastisol.

8. COMPOSITION of claim 7, characterized by the fact that said plastisol is from a homopolymer PVC.

9. COMPOSITION of claim 7, characterized by the fact that said plastisol is a mixture of PVC from emulsion and suspension polymerization processes.

10. COMPOSITION of claim 9, characterized by the fact that said plastisol is a mixture of PVC from emulsion and suspension processes at about 3:1 ratio.

11. COMPOSITION of claim 1, characterized by the fact that is comprises between 30% and 50% by weight of PVC.

12. COMPOSITION of claim 1, characterized by the fact that is additionally comprises alkali.

13. COMPOSITION of claim 12, characterized by the fact that the alkali is sodium hydroxide or ammonium hydroxide.

14. COMPOSITION of claim 12, characterized by the fact that it comprises between 0.5% and 15% alkali, more particularly between 5% and 10%, of the total composition weight.

15. COMPOSITION of claim 1, characterized by the fact that it additionally comprises expanding agents azodicarbonamide and/or calcium carbonate.

16. A BREATHABLE AND ABSORBENT POLYMERIC MATERIAL, characterized by the fact that it is obtained from a composition as described in one claim 1.

17. PROCESS TO OBTAIN A BREATHABLE AND ABSORBENT MATERIAL, characterized by the fact that it comprises the following steps:
laying a layer of a plastisol composition according to claim 1;
heating said layer for appropriate time and under appropriate temperature to gel the mass of said layer, to expel water vapor and to cure the gel.

18. PROCESS TO OBTAIN BREATHABLE AND ABSORBENT MATERIAL characterized by the fact that it comprises the following steps:
a) spreading a layer of a plastisol composition according to claim 1 over the surface of a moving conductor support;
b) heating for appropriate time and temperature to start plastisol gelling and water evaporation;
c) optionally, further repeating steps a and b;
d) laying a veil of textile substrate over a last layer of non-gelled plastisol;
e) heating until plastisol is gelled, water evaporates and the material exposed to heating is cured.

19. PROCESS of claim 18, characterized by the fact that it is made along a continuous processing line.

20. PROCESS of claim 18, characterized by the fact that the speed in the continuous processing line is between 9 and 25 meters per minute.

21. PROCESS of claim 18, characterized by the fact that the speed in the continuous processing line is between 12 and 13 meters per minute.

22. PROCESS of claim 18, wherein plastisol is spread by means of spread coating.

23. PROCESS of claim 18, characterized by the fact that heating is applied by 1 to 25 meter long ovens along a continuous processing line.

24. PROCESS of claim 18, characterized by the fact that heating is applied by 8 to 15 meter long ovens along a continuous processing line.

25. PROCESS of claim 18, characterized by the fact that two to five layers of PVC plastisol are applied.

26. PROCESS of claim 18 characterized by the fact that said e textile substrate is made of a substantially non-shrinking material upon heating, particularly a microfiber or a nonwoven material.

27. PROCESS of claim 18, characterized by the fact that the thickness of cured gel layers, not considering the textile substrate, vary between 0.03 mm and 3 mm.

28. PROCESS of claim 18, characterized by the fact that the thickness of the cured gel layers, not considering the textile substrate, vary between 0.3 mm and 1.6 mm.

29. PROCESS of claim 18, characterized by the fact that the conductive material over which plastisol is spread coated is a silicone-coated paper or other covering available to this purpose, with or without high relief.

30. PROCESS of claim 17, characterized by the fact that the heating temperature is between 130° C. and 230° C.

31. PROCESS of claim 17, characterized by the fact that the heating temperature is between 180° C. and 200° C.

32. PROCESS of claim 30, characterized by the fact that the exposure time to said temperature is between ten seconds and two minutes.

33. A BREATHABLE AND ABSORBENT POLYMERIC MATERIAL, characterized by the fact that it is obtained by means of a process according to claim 17.

34. USE OF A BREATHABLE AND ABSORBENT MATERIAL, obtained by a process according to claim 17, in the manufacture of automobile, furniture, clothing or footwear coverings.
